(19) United States
(12) Patent Application Publication
(10) Pub. No.: US 2007/0146708 A1
(43) Pub. Date: Jun. 28, 2007

(54) Mark structure, mark measurement apparatus, pattern forming apparatus and detection apparatus, and detection method and device manufacturing method

(75) Inventor: Tsuneyuki Hagiwara, Tokyo (JP)

Correspondence Address: OLIFF & BERRIDGE, PLC, P.O. BOX 19928, ALEXANDRIA, VA, 22320, US

(73) Assignee: NIKON CORPORATION, TOKYO (JP)

(21) Appl. No.: 11/602,977

(22) Filed: Nov. 22, 2006

Related U.S. Application Data
(60) Provisional application No. 60/789,608, filed on Apr. 6, 2006.

(30) Foreign Application Priority Data
Nov. 24, 2005 (JP) 2005-337920

(51) Int. Cl. G01B 11/00

(52) U.S. Cl. 356/401

(57) ABSTRACT

Since a wafer mark formed on a wafer has a periodic structure that weakens the intensity of even-order diffraction light rather than the intensity of odd-order diffraction light that is the reflected light of illumination light from a light source of an alignment system, measurement error of positional information of the wafer mark caused by the even-order diffraction light is reduced. Further, there is no need to set the duty ratio of the wafer mark to 1:1, so that the reflectance of the entire mark can be enhanced and it becomes possible to easily measure the mark position by the alignment system.

### CROSS-REFERENCE TO RELATED APPLICATIONS

This non-provisional application claims the benefit of Provisional Application No. 60/789,608 filed Apr. 6, 2006, the disclosure of which is hereby incorporated herein by reference in its entirety.

### BACKGROUND OF THE INVENTION

1. Field of the Invention

The present invention relates to, mark structures, mark measurement apparatuses, pattern forming apparatuses, detection apparatuses, detection methods, and device manufacturing methods. More particularly, the invention relates to a mark structure used to detect positional information thereof, a mark measurement apparatus that measures the positional information of the mark structure, a pattern forming apparatus equipped with the mark measurement apparatus, a detection apparatus that detects a mark structure including a corrugated pattern, a detection method in which the mark structure including the corrugated pattern is detected, and a device manufacturing method in which the detection method or the like is used.

2. Description of the Background Art

Recently, a CMP (Chemical Mechanical Polishing) process to make a wafer surface flat has been introduced in a semiconductor manufacturing process. With the introduction of the CMP process, an alignment mark (wafer mark) formed on a wafer could be deformed. For example, in the case a wafer mark is a diffraction grating being corrugated, the edge of the diffraction grating in a period direction wears away, and the mark is deformed. Further, the worn state of the edge on one side and the other side in the period direction becomes different, and the asymmetry of mark increases in some cases.

When the asymmetry increases due to deformation of the wafer mark, an error occurs in a detection result of the central position of the wafer mark, which is originally detected on the assumption that the mark is symmetrical. The error occurs because the amplitude and the phase of diffraction light from the wafer mark change due to asymmetry of the wafer mark, and in response to the change, the amplitude and the phase of a spatial frequency component in an intensity image of the wafer mark change, which causes a lateral deviation of the intensity image of the mark. Such an error is called a process offset. Since the asymmetry of the mark varies within a wafer and by each wafer, the process offset also varies within a wafer and by each wafer, and it is difficult to simply correct it.

To reduce the process offset, efforts have been made to make the wafer mark have finer grooves. When the mark has finer grooves, a deformation level of the mark caused by the CMP process is reduced and the symmetry of the mark can be maintained at a high level.

Meanwhile, several alignment sensors that are robust to asymmetry of the wafer mark in a diffraction grating state have been proposed. For example, an alignment sensor, which separates diffraction light of each order regarding a fundamental period from a wafer mark on a pupil conjugate position with respect to a wafer surface, makes positive and negative diffraction lights of the same order interfere with each other, and detects a mark position based on the phase of an interference signal, is proposed (e.g. refer to the pamphlet of International Publication No. 98/39689 and the like). Further, an alignment sensor, which separates and extracts a spatial frequency component of each order from an optical image that is formed by diffraction light from a wafer mark, and detects a mark position based on the phase of a spatial frequency component of order (odd-order in general) having smaller phase change due to the asymmetry of wafer mark, is also proposed (e.g. refer to Kokai (Japanese Unexamined Patent Application Publication) No. 2001-250766). Both of these alignment sensors separate a component corresponding to diffraction light of each order and measure a mark position. With this method, a mark position can be detected based on the phase of a spatial frequency component having smaller phase change to the increase of the asymmetry of wafer mark.

Generally, in the case the sectional shape of a wafer mark is a rectangular wave shape, it is believed that an odd-order spatial frequency component has smaller phase change due to the asymmetry of wafer mark than an even-order spatial frequency component. Therefore, in each of the alignment sensors, the mark position is detected using the odd-order spatial frequency component in many cases. When separating and extracting, for example, the odd-order spatial frequency component from an optical intensity image of a wafer mark with good accuracy, even-order diffraction light is better to be as small as possible. The reason is that the odd-order spatial frequency component originally occurs by beat between 0-order light and the odd-order diffraction light, but when even-order diffraction light is present, beat between the even-order diffraction light of high-order and the odd-order diffraction light generates the odd-order spatial frequency component, and the component becomes noise. However, the even-order diffraction light still occurs even if the wafer mark simply has finer grooves, and the even-order diffraction light blocks highly accurate separation and extraction of the odd-order spatial frequency component by the 0-order light and the odd-order diffraction light.

### SUMMARY OF THE INVENTION

The present invention has been made in consideration of the situation described above, and according to a first aspect of the present invention, there is provided a first mark structure, having a periodic structure that weakens intensity of even-order diffraction light rather than intensity of odd-order diffraction light out of a plurality of diffraction lights of a predetermined order or under generated by irradiation of illumination light, and whose duty ratio is not 1:1. Since this mark structure has a periodic structure that weakens the intensity of even-order diffraction light rather than the intensity of odd-order diffraction light out of a plurality of diffraction lights of a predetermined order or less generated by irradiation of illumination light, it becomes possible to reduce a beat component or the like between the odd-order diffraction light and the even-order diffraction light, which becomes noise when separating and extracting an odd-order spatial frequency component. As a consequence, the odd-order spatial frequency component generated by the beat between the 0-order diffraction light and the odd-order diffraction light can be separated and extracted highly accurately.

According to a second aspect of the present invention, there is provided a first mark measurement apparatus that measures the first mark structure of the present invention, the apparatus comprising: an illumination optical system that illuminates the mark structure with predetermined illumination light; and an image-forming optical system that guides the illumination light via the mark structure to form an intensity image of the mark structure, wherein the sum of a numerical aperture of the illumination optical system and a numerical aperture of the image-forming optical system is set to be smaller than a value obtained by dividing a wavelength of the illumination light by the shortest period out of the fundamental periods of the mark structure. In such a case, the even-order diffraction light of high-order generated from the mark structure is not made incident on the image-forming optical system, and does not contribute to the image-forming of an optical image of the mark structure, so that the optical image is formed by the 0-order light and the odd-order diffraction light. As a consequence, it becomes possible to separate and extract the odd-order spatial frequency component from the optical image highly accurately.

According to a third aspect of the present invention, there is provided a second mark measurement apparatus that measures the first mark structure of the present invention, the apparatus comprising: an illumination optical system that illuminates the mark structure with illumination light having a predetermined wavelength band; an image-forming optical system that guides the illumination light via the mark structure to form an intensity image of the mark structure; a photoelectric conversion element that photoelectrically detects the intensity image; a converter that performs the Fourier transform to a signal corresponding to the detected intensity image; and a detection apparatus that detects positional information of the mark structure based on a phase obtained by the Fourier coefficient of an odd-order harmonic component of the Fourier spectrum of the signal.

With this apparatus, the illumination light illuminating the mark structure has a predetermined wavelength band, in other words, the illumination light is broadband illumination light. Therefore, reduction in the detection accuracy of the position of the mark structure, which is caused by the interference of a film coated around the mark structure, can be prevented, and the position of the mark structure can be detected with good accuracy using the odd-order harmonic component of the Fourier spectrum of a signal corresponding to an intensity image of the mark structure.

According to a fourth aspect of the present invention, there is provided a third mark measurement apparatus, comprising: an illumination optical system that illuminates a period mark with predetermined illumination light; an image-forming optical system that guides 0-order diffraction light and odd-order diffraction light out of diffraction lights from the period mark to form an intensity image of the period mark; a photoelectric conversion element that photoelectrically detects the intensity image; a converter that performs the Fourier transform to a signal corresponding to the detected intensity image; and a detection apparatus that detects a position of the period mark based on a phase obtained by the Fourier coefficient of an odd-order harmonic component of the Fourier spectrum of the signal.

With this apparatus, since the intensity image of the period mark is formed by the 0-order diffraction light (O-order light) and the odd-order diffraction light, the odd-order harmonic component being the beat component between the 0-order light and the odd-order diffraction light can be separated and extracted from the intensity image with good accuracy.

According to a fifth aspect of the present invention, there is provided a pattern forming apparatus that forms a pattern on an object, comprising: any one of the first to third mark measurement apparatuses of the present invention that measures positional information of a mark formed on the object; and a controller that controls a position of the object at the time of forming the pattern, based on the positional information measured by the mark measurement apparatus.

With this apparatus, positional information of the mark formed on the object is measured by any one of the first to the third mark measurement apparatuses of the present invention with good accuracy, and the controller controls the position of the object at the time of forming the pattern, based on the positional information of the mark measured with good accuracy. Therefore, the pattern is formed on the object with good accuracy.

According to a sixth aspect of the present invention, there is provided a first device manufacturing method, including: a process in which a pattern is formed on an object using the pattern forming apparatus of the present invention; and a process in which processing is applied to the object on which the pattern is formed.

According to a seventh aspect of the present invention, there is provided a second mark structure including a corrugated pattern, having: a first component using a first period as a fundamental period; and a second component using a second period as a fundamental period, the second period being an even-multiple of the first period, wherein a duty ratio of the corrugated pattern is not 1:1. With this mark structure, the odd-order spatial frequency component can be separated and extracted with high accuracy.

According to an eighth aspect of the present invention, there is provided a pattern forming method, comprising irradiating exposure light on a glass substrate on which the second mark structure of the present invention is formed and forming the corrugated pattern on the substrate.

According to a ninth aspect of the present invention, there is provided a detection method in which a mark structure including a corrugated pattern is detected, the method comprising: irradiating illumination light on the mark structure via an illumination optical system; collecting diffraction light generated from the corrugated pattern by irradiation of the illumination light on a light-receiving plane of a light-receiving element by an image-forming optical system; and detecting positional information of the mark structure based on an image of the corrugated pattern detected by the light-receiving element, wherein the sum of a numerical aperture of the illumination optical system and a numerical aperture of the image-forming optical system is set to be smaller than a value obtained by dividing a wavelength of the illumination light by the shortest period of the corrugated pattern.

According to a tenth aspect of the present invention, there is provided a second device manufacturing method in which a circuit pattern is formed on a substrate, comprising: adjusting a position of the substrate based on positional information of a mark structure formed on the substrate that is detected using the detection method of the present invention, irradiating exposure light on the substrate, and forming the circuit pattern on the substrate.

According to an eleventh aspect of the present invention, there is provided a detection apparatus that detects a mark structure including a corrugated pattern, the apparatus comprising: an illumination optical system that illuminates illumination light onto the mark structure; and an image-forming optical system that forms an image of the corrugated pattern on a light-receiving plane of a light-receiving element, wherein the sum of a numerical aperture of the illumination optical system and a numerical aperture of the image-forming optical system is smaller than a value obtained by dividing a wavelength of the illumination light by the shortest period of the corrugated pattern.

### BRIEF DESCRIPTION OF THE DRAWINGS

In the accompanying drawings;

FIG. 1 is a view showing the schematic configuration of an exposure apparatus related to an embodiment of the present invention;

FIG. 2 is a view showing the schematic configuration of an alignment system;

FIG. 3A is a sectional view of a wafer mark related to an embodiment of the present invention;

FIG. 3B is a view showing the mark in a complex function;

FIG. 3C is a sectional view of a complex plane of the mark;

FIG. 3D is a view showing an alternating-current component of the mark;

FIG. 3E is a view showing a direct-current component of the mark;

FIG. 3F is a view showing complex amplitude;

FIG. 4A is a view showing the Fourier spectrum of a rectangular wave of a spatial frequency 1/6P;

FIG. 4B is a view showing the Fourier spectrum of a rectangular wave of a spatial frequency 1/P;

FIG. 4C is a view showing the spectrum of an amplitude distribution AC;

FIG. 5 is a view showing another example of a sectional shape of the wafer mark;

FIG. 6 is a view showing a general example of a sectional shape of a wafer mark;

FIG. 7A is a view showing an example of an intensity image of a rectangular wave pattern having a duty ratio of 1:1;

FIG. 7B is a view showing an example of an intensity image of a wafer mark M formed by 3 fine-groove marks;

FIG. 7C is a view showing an example of an intensity image of wafer mark M formed by 6 fine-groove marks;

FIG. 8 is view showing another example of a wafer mark (No. 1);

FIG. 9 is view showing another example of a wafer mark (No. 2); and

FIG. 10 is view showing another example of a wafer mark (No. 3).

### DESCRIPTION OF THE EMBODIMENTS

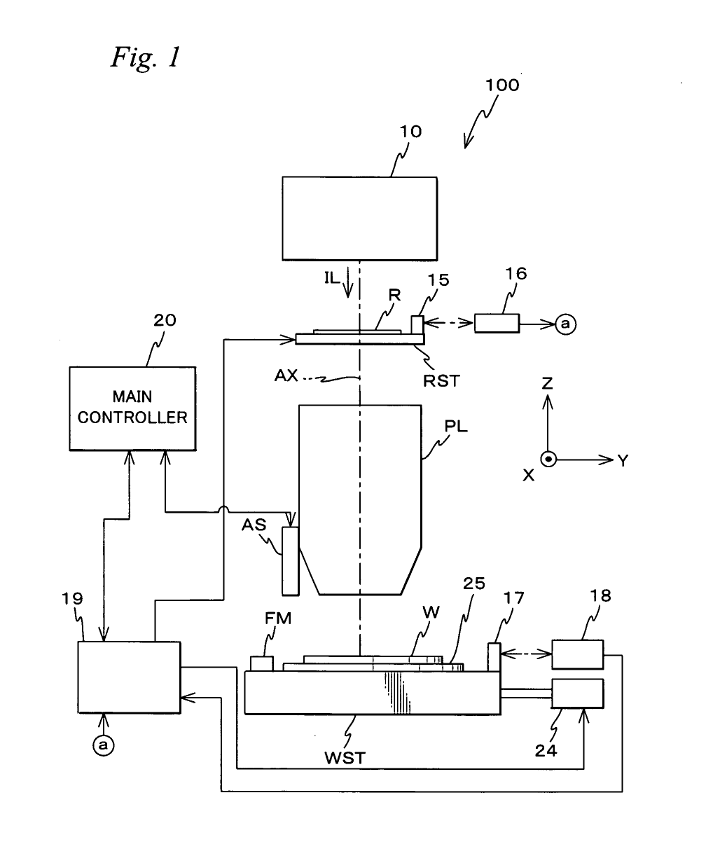

Hereinafter, one embodiment of the present invention will be described based on FIG. 1 to FIG. 6. FIG. 1 shows the schematic configuration of an exposure apparatus 100 that is a type of a pattern forming apparatus to which a mark structure and a mark measurement apparatus according to the embodiment are preferably applicable. Exposure apparatus 100 is a projection exposure apparatus by a step-and-scan method. As is shown in FIG. 1, exposure apparatus 100 is equipped with an illumination system 10, a reticle stage RST where a reticle R is held, a projection optical system PL, a wafer stage WST where a wafer is held, an alignment system AS for measuring a mark on the wafer, their control system, and the like.

Illumination system 10 is constituted in the similar manner to the illumination system disclosed in, for example, Kokai (Japanese Unexamined Patent Application Publication) No. 2001-313250 and the corresponding U.S. Patent Application Publication No. 2003/0025890, and the like. Illumination system 10 emits coherent illumination light for exposure (exposure light) IL such as laser light toward reticle stage RST. As exposure light IL, ArF excimer laser light (wavelength: 193 nm) is used, for example.

Reticle stage RST holds reticle R, for example, by vacuum chuck. Reticle stage RST is finely drivable within an XY plane by a reticle stage drive system (not shown) including, for example, a linear motor or the like, and also drivable in a Y-axis direction at a designated scanning speed. The position of reticle stage RST within a stage movement surface is measured by an interferometer 16. Based on a measurement value of interferometer 16, a stage controller 19 controls the position and the speed of reticle stage RST via the reticle stage drive system under instructions of a main controller 20.

As projection optical system PL, a both-side telecentric reduction optical system is used as an example. When reticle R is illuminated by exposure light IL from illumination system 10, a reduced image of a part of a circuit pattern or the like of reticle R is projected on wafer W, which is held on wafer stage WST (to be described later), via projection optical system PL.

Wafer stage WST is a stage that is freely drivable within the XY plane by a wafer stage drive system 24 including a linear motor or the like, and is also finely driven in a Z-axis direction. Further, a fine rotation of wafer stage WST (including a rotation around a Z-axis (θz rotation), a rotation around an X-axis (θx rotation) and a rotation around a Y-axis (θy rotation)) can be performed by wafer stage drive system 24. Wafer W is held on wafer stage WST via a holder 25 by vacuum chuck or the like. Therefore, the surface that holds wafer W is movable in directions of six degrees of freedom. Note that the rotation of the above-described wafer stage WST is performed around an optical axis AX of projection optical system PL.

A fiducial mark plate FM is arranged on wafer stage WST. On the surface (upper surface) of fiducial mark plate FM, various types of fiducial marks being a datum in alignment are arranged. The Z-position of the surface of fiducial mark plate FM is set substantially to the same height as the Z-position of the surface of wafer W that is held by holder 25.

The positions of wafer stage WST in directions of five degrees of freedom on other than the Z-axis direction are measured by an interferometer 18 via a movable mirror 17. Further, the Z-position of a surface of the wafer on wafer stage WST is measured by a measurement unit (not shown), for example, a multipoint focal position detection system or the like. Based on the measurement values of the measurement unit and interferometer 18, stage controller 19 performs positional control of wafer stage WST.

Note that a wafer stage including a stage movable within the XY plane and a table capable of being driven in directions of three degrees of freedom of Z-axis direction, θx direction, and θy direction on the stage may be used instead of wafer stage WST that can be driven in directions of six degrees of freedom.

According to instructions from main controller 20, stage controller 19 controls the position and the speed of reticle stage RST and wafer stage WST via the reticle stage drive system and wafer stage drive system 24. Stage controller 19 can independently control the both stages WST and RST and can perform synchronous scanning of the both stages WST and RST.

Main controller 20 is a computer that performs overall control of the entire apparatus. Main controller 20 controls various constituent elements in exposure apparatus 100 and performs overall control of processes performed in exposure apparatus 100, in addition to data transmission with a higher-level apparatus.

Alignment system AS is an off-axis alignment system, and is arranged near a −Y side of projection optical system PL. Alignment system AS detects positional information of an alignment mark (wafer mark) formed on wafer W. Alignment system AS photoelectrically detects a spatial intensity image of the wafer mark, and based on the detection result, detects the positional information of the wafer mark in a measurement field.

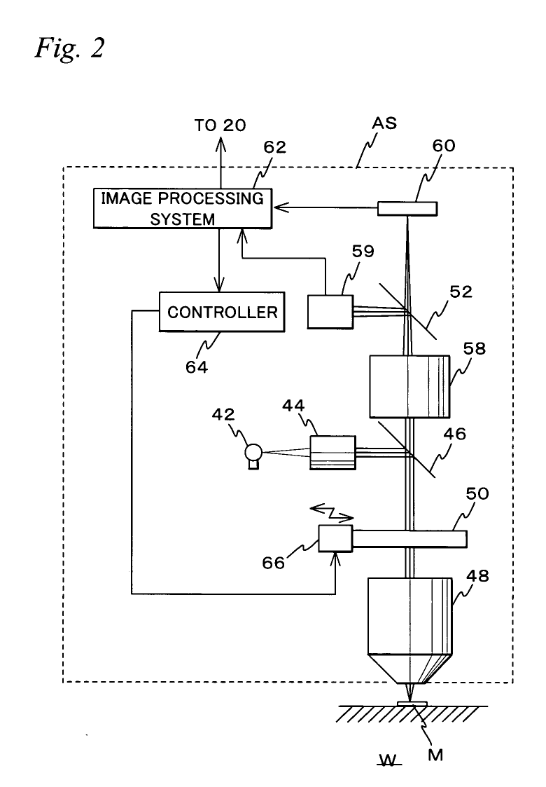

As an example, alignment system AS is equipped with a light source 42, a condenser lens 44, a half mirror 46, a first objective lens 48, a color filter 50, a second objective lens 58, a spectrometer 59, an imaging device 60, an image processing system 62, a controller 64 and the like, as is shown in FIG. 2.

Light source 42 emits light having a wavelength band of a predetermined width by which photoresist on wafer W is not exposed. As such light source 42, for example, a halogen lamp is suitably used. Illumination light emitted from the halogen lamp has a sufficiently wide wavelength band, and this prevents the reduction of detection accuracy due to thin film interference on a resist layer. Hereinafter, it is assumed that the wavelength band is from λ₀ nm to λ₁ nm. Herein, λ₀ is less than λ₁ (λ₀<λ₁), and for example, λ₀ is 530 nm and λ₁ is 900 nm.

Illumination light from light source 42 is converted into parallel beams by condenser lens 44. The parallel beams are reflected by half mirror 46 and collected on an area near a wafer mark M on wafer W via color filter 50 and first objective lens 48. In other words, alignment system AS episcopically illuminates wafer mark M.

Reflected light (diffraction light) is generated from wafer mark M illuminated by illumination light. Wafer mark M is a mark in a diffraction grating state as will be described later, and reflected light from the mark becomes 0-order light and ±n^{th} (n is a positive integer equal to or greater than 1 (natural number)) order diffraction light. Each diffraction light from wafer mark M is converted by first objective lens 48 into beams being parallel with each other, which pass different positions in a pupil plane that is in the Fourier transform relation with the wafer surface. In other words, each diffraction light passes a different position within the pupil plane of an image-forming optical system that is formed by first objective lens 48 and second objective lens 58. Each diffraction light is made incident on second objective lens 58 after having passed through color filter 50 and half mirror 46. Each diffraction light outgoing from second objective lens 58 is made incident on a half mirror 52. Each diffraction light reflected off half mirror 52 is made incident on spectrometer 59, and each diffraction light having passed through half mirror 52 is made incident on an imaging plane of imaging device 60. Imaging device 60 is, for example, a two-dimensional CCD (charge-coupled device). The imaging plane of imaging device 60 is in a conjugate position with the surface of wafer W, and an optical intensity image of wafer mark M is formed on the imaging plane of imaging device 60. Since the 0-order light is also made incident on the imaging plane of imaging device 60, the optical intensity image becomes a so-called bright field image where the 0-order light from wafer mark M contributes to image-forming.

Color filter 50 is connected to an actuator 66, and can be inserted/withdrawn to/from an optical axis of the image-forming optical system configured of first objective lens 48 and second objective lens 58 of alignment system AS, and can shield a predetermined position within the pupil plane of the image-forming optical system. Actuator 66 is controlled by controller 64. The control by controller 64 makes it possible to allow color filter 50 to shield light of arbitrary wavelength in order to prevent the light from passing the filter. In other words, the wavelength of light shielded by color filter 50 is determined by controller 64.

Spectrometer 59 can measure the intensity (i.e. spectral reflectance) with respect to each wavelength of the incident light. Since the wavelength band of diffraction light is from λ₀ nm to λ₁ nm, spectrometer 59 measures a spectral reflectance at each wavelength in the wavelength band. The measurement result of spectrometer 59 is sent to image processing system 62.

Imaging device 60 photoelectrically converts light intensity distribution on the imaging plane, which includes information corresponding to the optical intensity image of wafer mark M, into an electric signal, and sends it as an image signal to image processing system 62. Image processing system 62 performs image processing to the image signal. Specifically, image processing system 62 obtains the phase of at least one of a fundamental frequency component and an odd-order harmonic component (i.e. at least one odd-order spatial frequency component) of the image signal, which corresponds to one of the fundamental periods of wafer mark M in a diffraction grating state, by the Fourier transform, and converts the phase into a lateral deviation amount of wafer mark M from a designed position coordinate on wafer W. Although it is arbitrary to use a component of which order of the fundamental frequency component and its odd-order harmonic component in measurement, the best component can be selected based on actual measurement accuracy. For example, a component on which aberration of alignment optical system AS (such as coma and chromatic aberration to be described later) or asymmetry of mark has a small effect can be used. Further, a weighed average value of mark position that has been detected in the odd-order harmonic component of each order may be computed as a final mark position. Image processing system 62 computes a position coordinate of wafer mark M in an imaging field by such an image processing. The position coordinate of wafer mark M is sent to main controller 20.

Of the aberration of the image-forming optical system (first objective lens 48, second objective lens 58) in alignment system AS, it is mainly coma that affects a detection position of a mark. The coma of the image-forming optical system of alignment system AS changes the phase of the spatial intensity image of wafer mark M. Low-order coma is expressed by, for example, Z7 and Z8 in the Fringe Zernike polynomial. When considering Z7 as a pupil function, a pupil function F (ξ, η) is shown as in the following equation.
F(ξ,η)=Z7(ρ,ψ)=(3ρ³−2ρ)cos ψ (1)

Herein, ρ and ψ indicate pupil coordinates as shown in the following equation, and Z7 indicates phase delay of light on a pupil.

$$ρ = \sqrt{{ξ}^{2} + {η}^{2}} , ψ = {tan}^{- 1} \frac{η}{ξ} \qquad ( 2 )$$

Herein, when the spectrum of an object is f′ and f″, a cross modulation coefficient T(f′, f″) is defined by the following equation.
T(f′,f″)=∫∫σ(ξ,η)F(f′ξ,η)F*(f″+ξ,η)dξdη (3)

Herein, F(ξ, η) denotes a pupil function as described above. Asterisk (*) shows that it is a complex conjugate of the pupil function. Further, σ(ξ,η) denotes an effective light source. Herein, formation of the intensity image of wafer mark M, which is shown by a one-dimensional complex amplitude distribution o(x), is considered. The intensity image of wafer mark M, which is formed by partially coherent illumination, is shown by the following equation.

$$I ( {x}^{′} ) = {\int }_{- ∞}^{∞} {\int }_{- ∞}^{∞} T ( {f}^{′} , {f}^{″} ) O ( {f}^{″} ) exp ( 2 πⅈ {x}^{′} ( {f}^{′} - {f}^{″} ) ) ⅆ {f}^{′} ⅆ {f}^{″} \qquad ( 4 )$$

Herein, O(ξ) denotes the Fourier spectrum of o(x). Further, x′ is the converted coordinate on the image plane with respect to an object surface (wafer surface).

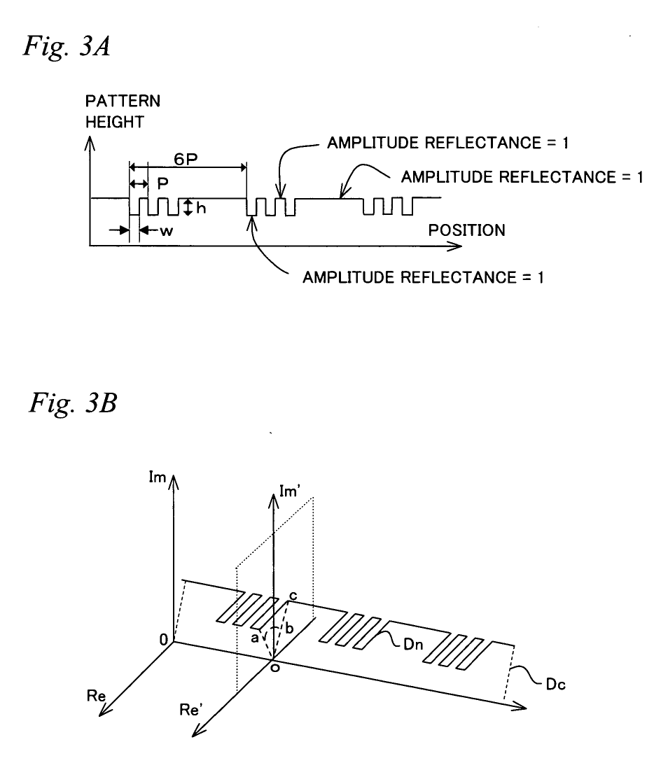

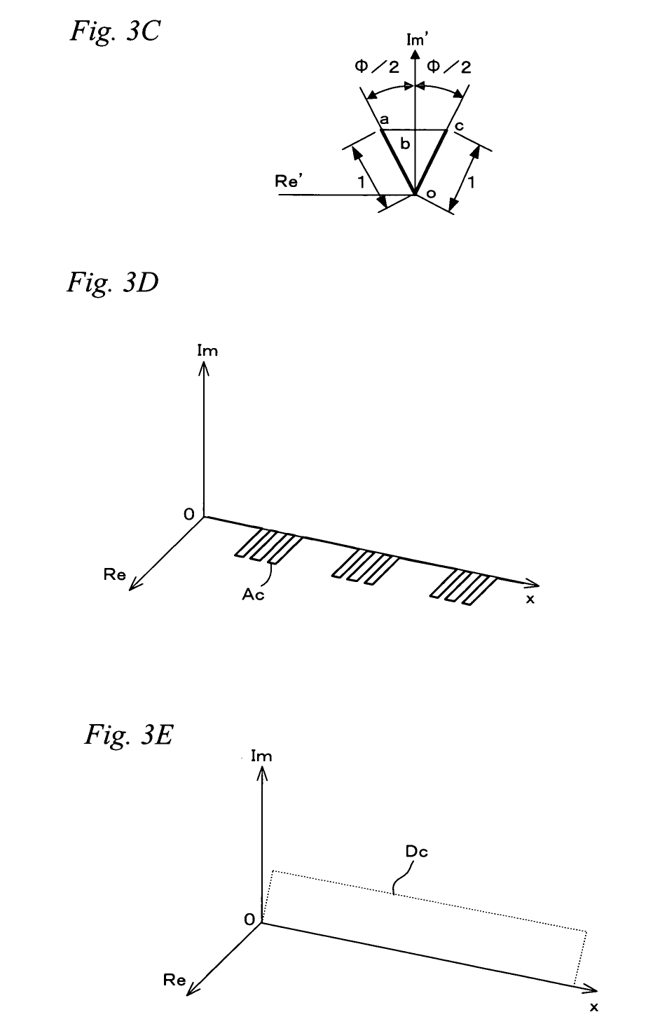

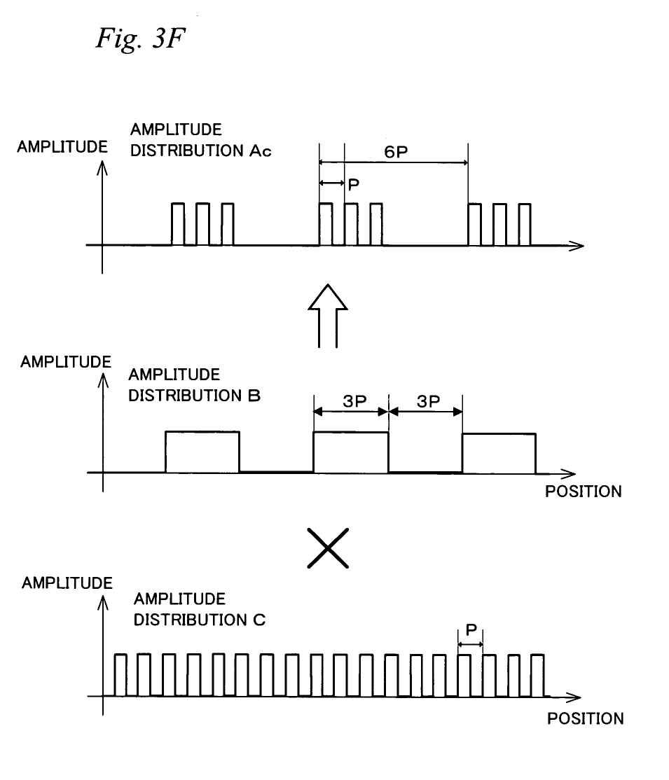

In the embodiment, as wafer mark M being the object (mark structure), a mark in a diffraction grating state having a periodic corrugated pattern, in which a line width of an engraved portion is narrower with respect to pitch and which is generally called a fine-groove type, is employed. FIG. 3A shows the sectional view of wafer mark M being the fine-groove mark. As is shown in FIG. 3A, sets of three fine grooves are formed on wafer mark M periodically at intervals of 6P. 6P is about 5 μm, for example. The interval between adjacent fine grooves in a set is “P”. A width W of each fine groove is set so as to be smaller than P (P>W).

Further, in the amplitude distribution, the amplitude reflectivity of a fine groove W portion is to be 1, and the amplitude reflectivity of the other portions is also to be 1. Moreover, a level difference is to be “h”. A reference code Dn in FIG. 3B denotes the mark displayed in a complex function. In the drawing, a reference code Re denotes a real number component and a reference code Im denotes an imaginary number component. Herein, FIG. 3C shows the sectional view of a mark Dn taken by a Re′-Im′ plane that is parallels with a Re-Im plane at the coordinate 0. Amplitude of a portion other than the fine grooves is indicated by a vector oc and its size is 1. Amplitude of the fine groove portion is indicated by a vector oa and its size is 1. Assuming that groove depth is h and the wavelength of illumination light is λ (which is considered to be an average wavelength in the case of broadband), an optical path length of episcopic illumination becomes twice due to reflection, so that an angle Φ formed by vector oc and vector oa is obtained by 2h/λ*2π=Φ.

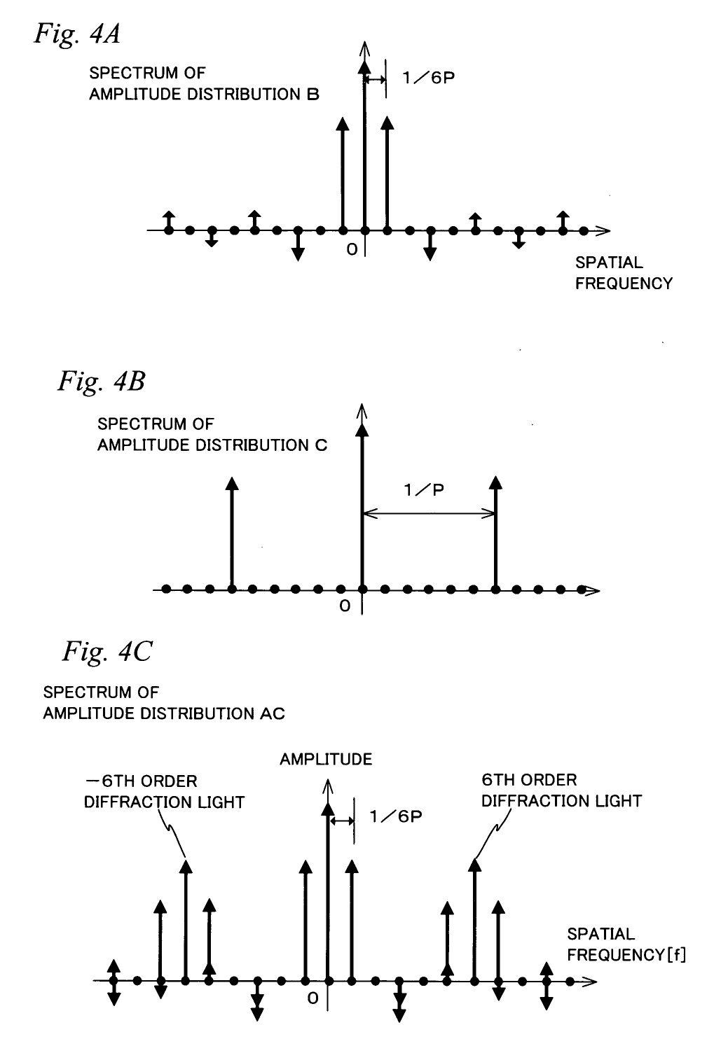

Meanwhile, it is possible to consider complex amplitude distribution Dn of the mark by dividing into a direct-current component Dc and an alternating-current component Ac. Alternating-current component Ac in this case is expressed by a component having amplitude parallel with vector ac in FIG. 3C, which is shown as in FIG. 3D. Direct-current component Dc is a component parallel with vector oc in FIG. 3C, which is shown in FIG. 3B and FIG. 3E. In the case diffraction light generated by complex amplitude distribution Dn is considered, it is effective to consider direct-current component Dc and alternating-current component Ac separately. Direct-current component Dc only generates 0-order diffraction light. On the other hand, alternating-current component Ac can be grasped as a result of the multiplication of periodic amplitude distributions B and C as shown in FIG. 3F. Further, by performing the Fourier transform to amplitude distributions B and C, the Fourier spectrum of each of amplitude distributions B and C is obtained as shown in FIG. 4A and FIG. 4B. Amplitude distribution B is a well-known rectangular wave having the period 6P, and a spectrum obtained by the Fourier transform is only an odd-order spectrum besides a 0-order component. The odd-order spectrum is generated in ±1/6P, ±3/6P, ±5/6P, ±7/6P and so on in a discrete manner. Amplitude distribution C is a period pattern having a period P, and the Fourier spectrum obtained by the Fourier transform is generated in ±1/P, ±2/P, ±3/P, ±4/P, ±5/P, ±6/P, and so on in a discrete manner besides the 0-order component.

The Fourier spectrum of alternating-current component Ac is their convolution, which is in the discrete Fourier spectrum as shown in FIG. 4C. Only odd-order diffraction light is generated between −6^{th} order diffraction light and +6^{th} order diffraction light. A lowest order even-order diffraction light, that is, ±6^{th} order diffraction light can be prevented from being made incident on an objective lens by fulfilling the relation of the following equation (5).
λ₀/P>(NA+NAi) (5)

Herein, a reference code NA denotes the numerical aperture of the image-forming optical system, and a reference code NAi denotes the numerical aperture of an illumination optical system. λ₀ denotes the shortest wavelength of illumination light as described above.

Therefore, only the odd-order diffraction light and the direct-current component contribute to image-forming, and an aerial image of a mark can be measured without being affected by the even-order diffraction light.

As is shown in FIG. 4C, the peak of the spectrum of the amplitude distribution of wafer mark M appear in the spatial frequency 0, ±1/6P, ±3/6P, ±5/6P and ±6/6P, but the spectrum intensity is 0 in the spatial frequency ±2/6P and ±4/6P. In other words, the amplitude distribution of wafer mark M includes the direct-current component, and only the 1^{st} order component, 3^{rd} order component, 5^{th} order component and 6^{th} order component of the components of the 6^{th} order or less corresponding to fundamental period P, and the 2^{nd} and 4^{th} even-order spatial frequency components smaller than the 6^{th} order are 0.

From the spatial frequency spectrum of FIG. 4C, the intensity of each order diffraction light from wafer mark M can be read out. In other words, besides 0-order diffraction light, diffraction light generated from wafer mark M is the ±1^{st} order diffraction light, ±3^{rd} order diffraction light, ±5^{th} order diffraction light and ±6^{th} order diffraction light of diffraction light of ±6^{th} order or less, and even-order diffraction light smaller than the 6^{th} order such as the 2^{nd} and 4^{th} order is not generated.

Further, in alignment system AS according to the embodiment, numerical aperture NAi of the illumination optical system (condenser lens 44, first objective lens 48) and numerical aperture NA of the image-forming optical system (first objective lens 48, second objective lens 58) are defined so as to fulfill the above-described equation (5). In this case, for example, NA equals 0.5 and NAi equals 0.5.

Therefore, diffraction light that is made incident on the image-forming optical system of alignment system AS is only the 0-order light and the ±1^{st} order, ±3^{rd} order and ±5^{th} order diffraction light corresponding to fundamental period P, and the ±6^{th} order diffraction light corresponding to fundamental period P is not be made incident on first objective lens 48, even if the ±6^{th} order diffraction light has the shortest wavelength. Therefore, the 6^{th} component in the spatial frequency distribution (spectrum) of wafer mark M whose image is actually formed on the imaging plane of imaging device 60 becomes 0.

Regarding wafer mark M, the sectional shape as shown in FIG. 5 can be employed in addition to the sectional shape shown in FIG. 3A. As is shown in FIG. 5, wafer mark M is different from the mark shown in FIG. 3A on the point where sets of two fine grooves are formed periodically at intervals of 4P. This mark also has a shape where two rectangular waves having different periods are synthesized, and the ratio of the two periods is an even-numbered ratio (1:4). The spatial frequency distribution (spectrum) of the mark is also a convolution of the spatial frequency distributions (spectra) of two rectangular waves, and peaks appear in the spatial frequency of 0, ±1/6P, ±3/6P, ±4/6P in the spectrum, but the spectrum intensity is 0 in the spatial frequency ±2/6P. Further, as is described above, due to the relation of λ₀/P>(NA+NAi), diffraction light incident on the image-forming optical system of alignment system AS is only 0-order light and the ±1^{st} order and ±3^{rd} order diffraction light corresponding to fundamental period P, and the ±4^{th} order diffraction light corresponding to fundamental period P is not be made incident on first objective lens 48, even if the ±4^{th} order diffraction light has the shortest wavelength. Therefore, diffraction light that contributes to the image-forming of wafer mark M whose image is formed on the imaging plane of imaging device 60 is only the 0-order light and the odd-order diffraction light.

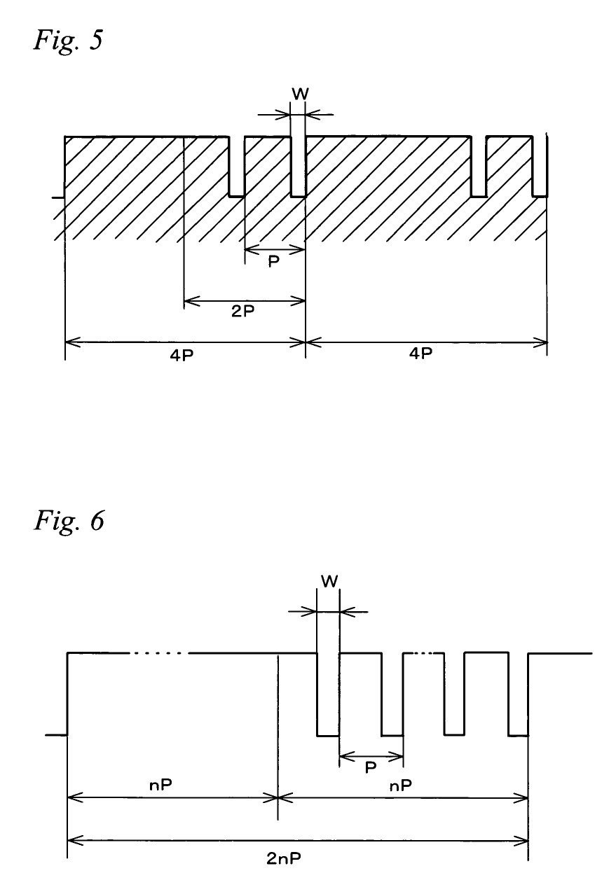

The sectional shapes shown in FIG. 3A and FIG. 5 are generalized into the cross-sectional shape of a wafer mark shown in FIG. 6. As is shown in FIG. 6, in this sectional shape, sets of n-number fine grooves are periodically formed at intervals of nP (n is a positive integer). The interval between adjacent fine grooves in the set is P. A width W of each fine groove is set so as to be smaller than P (P>W). Based on the relation between such a shape and the numerical aperture of each optical system of alignment system AS, diffraction light that contributes to the image-forming of the intensity image of the mark on the imaging plane of imaging device 60 is only the 0-order light and the odd-order diffraction light up to the (2n−1)^{th} order.

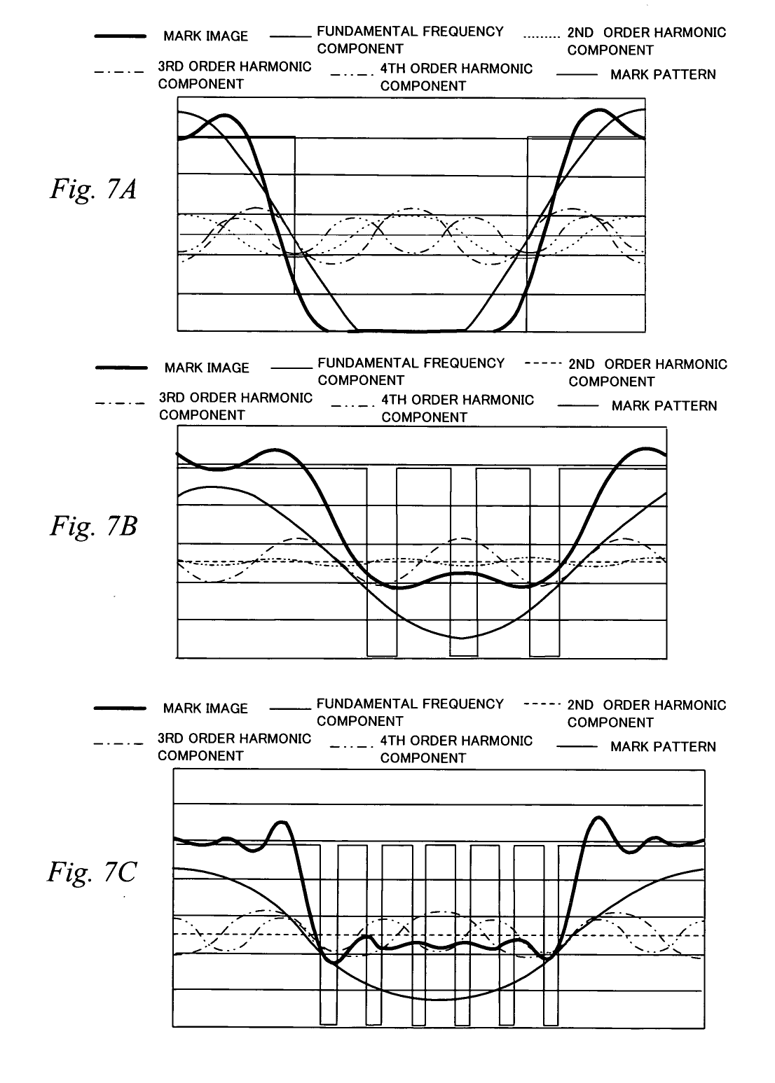

Wafer mark M generalized in FIG. 6 is a mark having a periodic structure that weakens the intensity of the even-order diffraction light rather than the intensity of the odd-order diffraction light with respect to incident light to alignment system AS. FIG. 7A shows the spatial intensity image of a mark having the rectangular wave of a duty ratio of 1:1 as its sectional shape. Further, FIG. 7B shows the spatial intensity image of a mark having the sectional shape shown in FIG. 3A. Moreover, FIG. 7C shows the spatial intensity image of a mark with n=6 (i.e. having sets of 6 fine grooves). FIG. 7A, FIG. 7B and FIG. 7C show the intensity image of the mark (mark image), the fundamental frequency component, the 2^{nd} order harmonic component, 3^{rd} order harmonic component, and 4^{th} order harmonic component of the mark image together with the mark pattern of the mark.

Since the mark pattern shown in FIG. 7A has a duty ratio of 1:1, the intensity image ideally includes only the odd-order spatial frequency component. However, an even-order spatial frequency component appears besides the odd-order spatial frequency component in an actual aerial image. Herein, comparing the even-order harmonic component with the odd-order harmonic component in FIG. 7A and FIG. 7B, they show that the amplitude of the 2^{nd} order and 4^{th} order harmonic components in FIG. 7B is significantly smaller than the amplitude of the 2^{nd} order harmonic component in FIG. 7A. On the other hand, although the amplitude of the 1^{st} order (fundamental) frequency component and 3^{rd} order harmonic component shown in FIG. 7B is slightly smaller than their amplitude in FIG. 7A, the amplitude maintains a certain level. In other words, in the mark shown in FIG. 7B, the intensity of the even-order harmonic component is reduced comparing to the odd-order harmonic component. The similar phenomenon applies to FIG. 7C. Consequently, it is possible to conclude that the mark shown in FIG. 3A or the like is a mark structure that has a periodic structure that weakens the intensity of the even-order diffraction light rather than the intensity of the odd-order diffraction light with respect to incident light and whose duty ratio is not 1:1.

The characteristics of the shape of wafer mark M bring better effect to the measurement accuracy of a mark position. For example, there is an advantage that aberration of image-forming optical system becomes easily controlled in alignment systemAS. Herein, consideration is given in detail to the relation between the sectional shape of wafer mark M and the aberration of the image-forming optical system of alignment system AS. Herein, a shorter period of wafer mark M of the fundamental periods is to be P=1/fₕ. When the periodic structure of wafer mark M is assumed to be the one-dimensional distribution of amplitude and phase, o_{bfr}(x′) of the following equation is obtained. Reference code x′ denotes the converted coordinate on the image plane with respect to the object surface (wafer surface).

$${o}_{bfr} ( {x}^{′} ) = [ \begin{matrix}{c}_{0} + {c}_{+ 1} exp ( ⅈ ( 2 π {x}^{′} ( {f}_{h} ) + {θ}_{+ 1} ) ) + {c}_{- 1} exp ( ⅈ ( 2 π {x}^{′} ( - {f}_{h} ) - {θ}_{- 1} ) ) + \\ {c}_{+ 2} exp ( ⅈ ( 2 π {x}^{′} ( 2 {f}_{h} ) + {θ}_{+ 2} ) ) + {c}_{- 2} exp ( ⅈ ( 2 π {x}^{′} ( - 2 {f}_{h} ) - {θ}_{- 2} ) ) + \\ {c}_{+ 3} exp ( ⅈ ( 2 π {x}^{′} ( 3 {f}_{h} ) + {θ}_{+ 3} ) ) + {c}_{- 3} exp ( ⅈ ( 2 π {x}^{′} ( - 3 {f}_{h} ) - {θ}_{- 3} ) ) + \\ {c}_{+ 4} exp ( ⅈ ( 2 π {x}^{′} ( 4 {f}_{h} ) + {θ}_{+ 4} ) ) + {c}_{- 4} exp ( ⅈ ( 2 π {x}^{′} ( - 4 {f}_{h} ) - {θ}_{- 4} ) ) + \\ {c}_{+ 5} exp ( ⅈ ( 2 π {x}^{′} ( 5 {f}_{h} ) + {θ}_{+ 5} ) ) + {c}_{- 5} exp ( ⅈ ( 2 π {x}^{′} ( - 5 {f}_{h} ) - {θ}_{- 5} ) )\end{matrix} ] \qquad ( 6 )$$

Herein, reference code c₀, c₋₁, c₊₁, c₋₂, c₊₂, c₋₃, c₊₃, c₋₄, c₊₄, c₋₅ and c₊₅ denote the Fourier coefficients and reference code θ₋₁, θ₊₁, θ₋₂, θ₊₂, θ₋₃, θ₊₃, θ₋₄, θ₊₄, θ₋₅ and θ₊₅ denote the phase of each spectrum.

As is described above, the components of diffraction light that contribute to the image-forming of wafer mark M is substantially only the 0-order light (direct-current component) and the odd-order diffraction light. Thus, Fourier spectrum o_{aft}(x′) shown in the following equation is obtained as the complex amplitude of wafer mark M.

$${o}_{aft} ( {x}^{′} ) = [ \begin{matrix}{c}_{0} + {c}_{+ 1} exp ( ⅈ ( 2 π {x}^{′} ( {f}_{h} ) + {θ}_{+ 1} ) ) + {c}_{- 1} exp ( ⅈ ( 2 π {x}^{′} ( - {f}_{h} ) - {θ}_{- 1} ) ) + \\ \\ {c}_{+ 3} exp ( ⅈ ( 2 π {x}^{′} ( 3 {f}_{h} ) + {θ}_{+ 3} ) ) + {c}_{- 3} exp ( ⅈ ( 2 π {x}^{′} ( - 3 {f}_{h} ) - {θ}_{- 3} ) ) + \\ \\ {c}_{+ 5} exp ( ⅈ ( 2 π {x}^{′} ( 5 {f}_{h} ) + {θ}_{+ 5} ) ) + {c}_{- 5} exp ( ⅈ ( 2 π {x}^{′} ( - 5 {f}_{h} ) - {θ}_{- 5} ) )\end{matrix} ] \qquad ( 7 )$$

As is shown in equation (4) and equation (7) described above, the odd-order harmonic component included in the spatial intensity image of wafer mark M consists of the combination of the 0-order (direct-current) component and the odd-order Fourier component of the wafer mark. This is a very important conclusion from the viewpoint of separating the aberration of the image-forming optical system of alignment system AS from the position of wafer mark M. Supposing that N is an odd number, the N^{th} order component I_{hH-odd}(x′) included in the intensity image of wafer mark M is shown by the following equation.
I_{hH-dd}(x′)=2c₀c_{+N}T(Nfₕ,0)cos(2πx′Nfₕ+θ+N)+2c₀c_{-N}T(−Nfₕ,0)cos(−2πx′Nfₕ−θ_{-N})=2c₀c_{+N}cos(2πx′Nfₕ+θ_{+N}+φ_{hN})+2c₀C_{-N}cos(2πx′Nfₕ+θ_{-N}+φ_{hN}) (8)

Herein, reference code φ_{hN} denotes an aberration amount that the N-th order diffraction light suffers, which is shown by the following equation.

$${ϕ}_{hN} = {tan}^{- 1} \frac{Im ( T ( 0 , {Nf}_{h} ) )}{Re ( T ( 0 , {Nf}_{h} ) )} \qquad ( 9 )$$

φ_{hN} is a known amount when the aberration amount of the image-forming optical system is known, and does not change due to wafer mark M. Therefore, an amount that the aberration of the image-forming optical system gives to the diffraction light of each order is a known fixed amount (offset). For any mark, influence of the aberration of the image-forming optical system can be removed when the phase is corrected by the offset.

In the embodiment, the offset is measured in advance for each order of the spatial frequency component. For example, the offset in the 3^{rd} order harmonic component can be detected, for example, from the deviation between a mark position measured based on the spatial frequency component created by the 0-order light and the 1^{st} order diffraction light and a mark position measured based on the spatial frequency component created by the 0-order light and the 3^{rd} order diffraction light. In the case of wafer mark M in the embodiment, the spatial frequency component by the even-order diffraction light becomes substantially 0, so that the offset can be detected with good accuracy.

The measurement result is stored in a storage unit (not shown), and controlled by image processing system 62. On wafer alignment (to be described later), when measuring the mark position based on a signal corresponding to the intensity image of the mark, image processing system 62 corrects the measured mark position using an offset corresponding to the order of a spatial frequency component used in the detection.

Note that the aberration amount could be different in the field of first objective lens 48 in some cases. In such cases, the above-described offset (aberration amount) only has to be measured on a plurality of sampling points in the field. Further, in the case age-based aberration fluctuation is expected, an offset (aberration amount) stored in the storage unit (not shown) only has to be updated by regularly measuring aberration.

Meanwhile, θ_{-N} and θ_{+N} in the above-described equation (8) denote the position and sectional shape of wafer mark M. The sectional shape shows asymmetry caused by the influence of the manufacturing process (process) of a semiconductor device or the like. Image processing system 62 of alignment system AS computes θ_{-N}, θ_{+N} and mark pitch, and the position of wafer mark M of harmonic component of each order and the measurement result of the position of wafer mark M desirably has smaller dispersion among the positions in wafer W or a plurality of wafers W. Then, image processing system 62 of alignment system AS selects and measures a spatial frequency component of an order (e.g. 3^{rd} or 5^{th}) having smaller dispersion in the measurement result. This order is determined in advance. Further, a result obtained by averaging the measurement results of mark positions in a spatial frequency component of an order having smaller dispersion may be employed as the final mark position. In the case of using the mark shown in FIG. 3A, the order is an odd-order that is at least one of the 1^{st} order, 3^{rd} order and 5^{th} order. For example, an average value of a mark position, which has been obtained from the 3^{rd} order spatial frequency component and to which the foregoing correction by the offset has been performed, and a mark position, which has been obtained from the 5^{th} order spatial frequency component and to which the foregoing correction by the offset has been performed, can be used as the final mark position.

Meanwhile, since alignment system AS uses a broadband light source, the correction of mark position is performed taking into consideration not only coma of the image-forming optical system but also chromatic aberration of the image-forming optical system likewise. Generally, when the image-forming optical system of alignment system AS has chromatic aberration, deviation occurs in the image-forming position of a mark image in each wavelength, and the intensity image of the mark becomes a synthetic image by the weighted average sum of the mark image in each wavelength. Then, the mark on the wafer has different reflectance depending on the wavelength of illumination light to be irradiated, and thus the intensity of the mark image in each wavelength varies. Due to the spectral reflectance characteristics, the position of the mark image, that is, the position of the synthesized image by the weighted average of the mark images deviates from the position of a mark image formed originally when chromatic aberration is not present, and as a result, the lateral deviation is generated in the measurement result of mark position. Thus, exposure apparatus 100 according to the embodiment also corrects the lateral deviation of mark position caused by the chromatic aberration in the image-forming optical system of alignment system AS.

For the chromatic aberration correction, alignment system AS is equipped with color filter 50 and spectrometer 59 as shown in FIG. 2. Hereinafter, description will be made for the correction procedure of chromatic aberration in alignment system AS of exposure apparatus 100.

First, a wafer (datum wafer) on which a mark whose spectral reflectance characteristics is known and, for example, has the structure shown in FIG. 3A is formed is prepared. Then, the datum wafer is loaded on wafer stage WST by a carriage system (not shown). Next, main controller 20 drives wafer stage WST via stage controller 19 and positions the mark within the measurement field (imaging field in this case) of alignment system AS. Subsequently, under instructions of main controller 20, alignment system AS (controller 64) adjusts and sets color filter 50 so as to allow only one odd-order diffraction light out of diffraction light of each order, which is to pass color filter 50, to pass the filter, and furthermore, only light having a particular wavelength out of the odd-order diffraction light is allowed to pass the filter. Then, under instructions of main controller 20, alignment system AS (controller 64) measures the spectral reflectance of light having the wavelength by spectrometer 59, and image processing system 62 measures a mark position based on an image signal obtained by imaging by imaging device 60. Likewise, while changing the wavelength of light passing the filter, alignment system AS measures the spectral reflectance and the mark position with respect to each wavelength.

In the case a mark position to be measured deviates due to changing the wavelength of light passing the filter, it means that the lateral deviation is generated in the mark position due to chromatic aberration. Image processing system 62 computes a relative positional deviation amount of mark position corresponding to each wavelength, and stores it in the storage unit (not shown).

Such a relation between the wavelength and the lateral deviation amount of mark position is measured with respect to each odd-order diffraction light, and a relation between the wavelength of all odd-order diffraction lights, which could contribute to the image-forming on the imaging plane of imaging device 60, the spectral reflectance and the mark positional deviation amount is obtained and stored in the storage unit (not shown).

Actually, the spectral reflectance characteristics of wafer mark M on wafer W varies depending on each mark. Thus, in the case of imaging wafer mark M, alignment system AS also measures its spectral reflectance characteristics. As is described above, when the positional deviation amount of mark changes due to the wavelength of light, a mark positional deviation amount due to the chromatic aberration of the intensity image of the wafer mark, which is formed by light having a particular wavelength band, becomes a weighted average sum corresponding to the spectral reflectance characteristics of the positional deviation amount of mark in each wavelength. Then, alignment system AS measures the spectral reflectance characteristics of wafer mark M measured by spectrometer 59, and computes the weighted average of the lateral deviation amount of mark position by using the ratio between the spectral reflectance characteristics at that time and a spectral reflectance being the datum in the wavelength is used as weight, as the chromatic aberration correction amount at that time, and then only has to correct the measurement result of the mark position using the chromatic aberration correction amount.

<Exposure Operation>

Next, an exposure operation in exposure apparatus 100 will be described. It is assumed that reticle R has already been loaded on reticle stage RST and predetermined preparatory operations such as reticle alignment and baseline measurement have been completed.

First, wafer W to be exposed is loaded on wafer stage WST by the carriage system (not shown). Wafer W is a wafer on which one or more layers of shot area(s) has/have already been formed. A search alignment mark and wafer mark M that have the above-described periodic structure are attached on the shot area.

Subsequently, main controller 20 moves wafer stage WST, which holds wafer W by vacuum chuck to below alignment system AS via stage controller 19 to perform search alignment and wafer alignment. The processing of the search alignment and the wafer alignment (e.g. alignment by the EGA method) is disclosed in, for example, Kokai (Japanese Unexamined Patent Application Publication) No. 61-044429 and the corresponding U.S. Pat. No. 4,780,617, and the like. In the search alignment and the wafer alignment, positional information of various types of alignment marks formed on wafer W in an XY coordinate system is measured using alignment system AS. For this measurement, in order to position a plurality of shot areas (sample shots) on which the marks are attached below alignment system AS, wafer stage WST is sequentially moved via stage controller 19.

When performing the mark positional measurement, alignment system AS irradiates illumination light on wafer mark M. By this irradiation, light reflected or diffracted on the surface of wafer W is received by imaging device 60 via first objective lens 48, second objective lens 58 and the like. Imaging device 60 converts the image of wafer mark M formed on the imaging plane into an electric signal, and outputs the signal to image processing system 62 as an image signal. Image processing system 62 separates and extracts at least the 1^{st} odd-order spatial frequency component that is used for measuring a mark position. Image processing system 62 computes the mark position based on the phase of the odd-order spatial frequency component that has been extracted as described above and the mark pitch. Then, the mark position is corrected using a correction amount by the coma and a correction amount by the chromatic aberration of each order. A result obtained by the correction is the final mark position.

The mark positional information in the imaging field of alignment system AS computed by image processing system 62 is sent to main controller 20. Main controller 20 computes the position coordinate of wafer mark M on the XY coordinate system based on the mark positional information and the positional information of wafer stage WST obtained from interferometer 18 via stage controller 19.

In the wafer alignment, main controller 20 statistically computes an arrangement coordinate system on wafer W by the positional information of wafer mark M measured by alignment system AS, as is shown in, for example, Kokai (Japanese Unexamined Patent Application Publication) No. 61-044429 and the corresponding U.S. Pat. No. 4,780,617. Then, based on the arrangement coordinate system, exposure by a step-and-scan method is performed on the shot area. Thus, highly accurate overlay exposure is realized to the shot area that has been already formed on wafer W.

As is described in detail so far, according to the embodiment, since wafer mark M formed on the wafer has the periodic structure that weakens the intensity of the even-order diffraction light rather than the intensity of the odd-order diffraction light that is the reflected light of the illumination light from light source 42, the odd-order spatial frequency component of the spatial intensity image of wafer mark M can be detected with good accuracy. As a result, measurement error of the positional information of wafer mark M is reduced. Further, since it becomes unnecessary to set the duty ratio of wafer mark M to 1:1, the reflectance of the entire mark is enhanced and the position of wafer mark M can be measured by alignment system AS more easily.

Further, according to the embodiment, the periodic structure of wafer mark M includes a spatial frequency component using period P as the fundamental period and a spatial frequency component using 2nP being the even-multiple of the period P as the fundamental period. In this manner, when the ratio of periods having two different fundamental frequency components, which are included in the sectional shape of the wafer mark, is set to an even-numbered ratio, it becomes possible to reduce the intensity of an even-order harmonic component of low order such as the 2^{nd} order even if the duty ratio of wafer mark M is not 1:1.

Particularly, in the embodiment, a mark having a periodic structure, which has period P as the fundamental period and where periodic corrugated pattern having an overall length of nP in a period direction is arranged at intervals of period 2np, is employed as wafer mark M, and width W of a recessed portion of the corrugated pattern in the period direction is set to become shorter than the half of period P. In such a structure, an optical image of wafer mark M surely includes two fundamental frequency components whose relation with each other is in the even-numbered ratio. Further, width W of the recessed portion in a period direction only has to be shorter than the half of period P, and a mark position to be measured is not be affected by the width of the recessed portion. This increases the degree of freedom in design of wafer mark M. Therefore, the pitch of mark can be made even finer, and highly accurate alignment can be performed.

Further, according to the embodiment, alignment system AS is set so that the sum (NAi+NA) of numerical aperture NAi of the illumination optical system that illuminates predetermined illumination light on wafer mark M, and numerical aperture NA of the image-forming optical system that guides illumination light via wafer mark M to form the intensity image of wafer mark M becomes smaller than a value obtained by dividing the wavelength of illumination light by period P. With this method, the even-order diffraction light of high-order is not be made incident on the image-forming optical system of alignment system AS, and the even-order diffraction light of high-order does not contribute to the image-forming of the intensity image of the mark.

More specifically, according to the embodiment, the illumination light in alignment system AS is broadband light having a predetermined wavelength band, and the sum (NAi+NA) of numerical aperture NAi of the illumination optical system and numerical aperture NA of the image-forming optical system in alignment system AS is set to become smaller than a value obtained by dividing the shortest wavelength λ₀ of the illumination light by period P. In other words, all the even-order diffraction light of high-order of the illumination light (light having the wavelength λ₀ to λ₁) is not made incident on the image-forming optical system of alignment system AS, so that the even-order diffraction light of high-order will be completely prevented from being made incident on the image-forming optical system.

Further, alignment system AS according to the embodiment is equipped with: the illumination optical system that illuminates the wafer mark with broadband illumination light; the image-forming optical system (first objective lens 48 and second objective lens 58) that guides the illumination light via wafer mark M to form the intensity image of wafer mark M; imaging device 60 that photoelectrically detects the intensity image; and image processing system 62 that performs the Fourier transform to a signal corresponding to the detected intensity image and measures positional information of wafer mark M based on the odd-order harmonic component of the Fourier spectrum of the signal. In other words, the mark position of wafer mark M is measured based on the odd-order harmonic component having large amplitude using broadband illumination light, so that it becomes possible to measure the mark position with good accuracy in a state of high S/N ratio regardless of interference of film.

Further, in the embodiment, image processing system 62 corrects the positional information of wafer mark M based on positional deviation data of the intensity image of wafer mark M, which is caused by chromatic aberration of the image-forming optical system (first objective lens 48, second objective lens 58) of alignment system AS, so that it becomes possible to measure the mark position with good accuracy regardless of the chromatic aberration of the image-forming optical system of alignment system AS.

In this case, in the embodiment, when correcting the positional information of wafer mark M, image processing system 62 uses the positional deviation data of mark image caused by chromatic aberration that is different depending on the order of the odd-order harmonic component for measuring the positional information of wafer mark M. Because the passing positions within the pupil plane of the image-forming optical system (first objective lens 48, second objective lens 58) through which the diffraction light of each order passes are different, it is necessary to compute chromatic aberration for each order beforehand.

To realize the chromatic aberration correction, alignment system AS is further equipped with spectrometer 59 that measures the spectral reflectance characteristics of wafer mark M. Image processing system 62 computes the mark positional deviation data regarding the chromatic aberration of the image-forming optical system of alignment system AS, based on the spectral reflectance characteristics of wafer mark M to the wavelength of illumination light measured by spectrometer 59. Then, based on the computed positional deviation data of wafer mark M due to the chromatic aberration of the image-forming optical system, the measurement position of wafer mark M is corrected. With this operation, it becomes possible to accurately correct chromatic aberration based on the actually measured spectral reflectance characteristics.

Further, alignment system AS is further equipped with color filter 50 that can adjust the wavelength of diffraction light that contributes to the image-forming of the intensity image of wafer mark M. Color filter 50 is used when obtaining the relation between the spectral reflectance characteristics of wafer mark M in spectrometer 59 and the positional deviation of the intensity image of wafer mark M. When color filter 50 is used in this manner, the relation between the wavelength of illumination light and the lateral deviation of mark, that is, the positional deviation caused by chromatic aberration can be obtained with good accuracy.

Further, according to the embodiment, alignment system AS guides the 0-order light and the odd-order diffraction light out of diffraction light from wafer mark M to form the intensity image of wafer mark M, photoelectrically detects the intensity image, performs the Fourier transform to an image signal corresponding to the detected intensity image, and measures the position of the wafer mark based on the odd-order harmonic component of the Fourier spectrum. With this operation, beat between the even-order diffraction light and the odd-order diffraction light is not be included in a mark image as the odd-order spatial frequency component, so that the mark position can be measured with good accuracy.

Note that color filter 50 has another use method. For example, in the case the 0-order light from the mark is small, the wavelength of diffraction light is changed to increase the intensity of the 0-order light using color filter 50, and the wavelength of diffraction light that contributes to the image-forming of intensity image may be adjusted. As the 0-order light is intensified, the contrast of the intensity image on the imaging plane of imaging device 60 becomes larger, and it becomes possible to measure the mark position with higher accuracy. Such use of color filter 50 is not limited to an alignment system using broadband illumination light.

Meanwhile, although the illumination light having a predetermined wavelength band (λ₀ to λ₁) is employed in the embodiment, light having wavelength selected from a plurality of wavelengths may be used. In other words, the present invention can also be applied to an alignment system that can selectively uses light having wavelength with which mark measurement accuracy is best, in accordance with the wafer mark. That is, the mark position is corrected using a chromatic aberration amount corresponding to the selected wavelength.

In alignment system AS according to the embodiment above, unlike the alignment sensor disclosed in the pamphlet of International Publication No. 98/39689, an interference signal is not taken out on the pupil conjugate position of the image-forming optical system but the Fourier transform is performed to a wafer mark image that is achromatized in the space of the mark image. Thus, in the alignment system according to the embodiment above, a light source having a broadband wavelength region can be used, and the mark position can be measured highly accurately regardless of generation of optical noise such as speckle.

Note that various modifications can be made to wafer mark M of the embodiment above. Hereinafter, a few modified examples will be described.

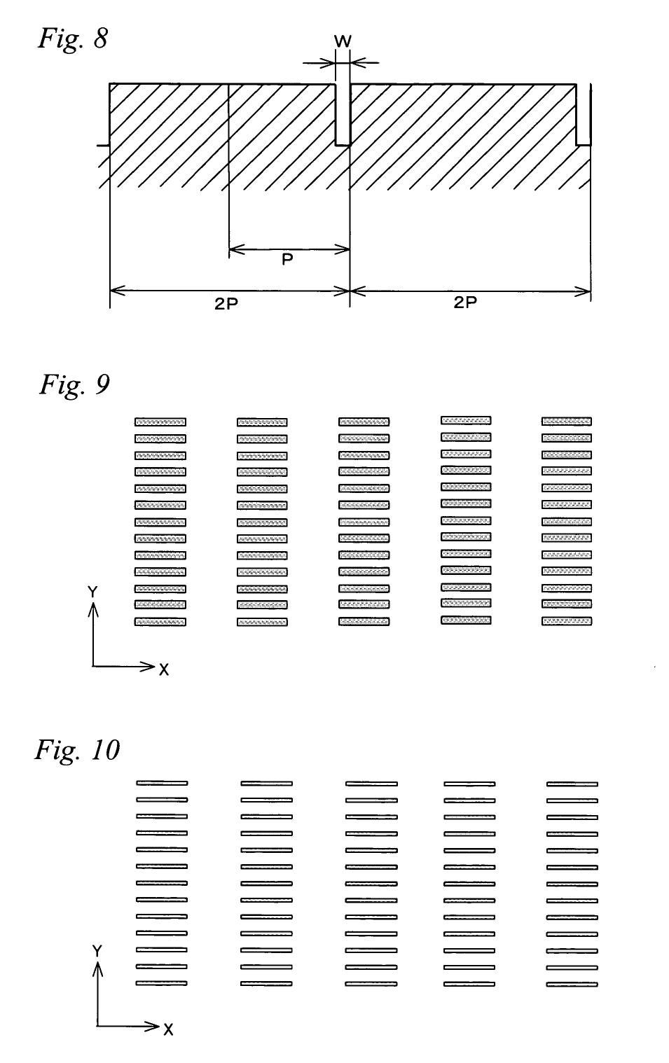

For example, the fine-groove mark as shown in FIG. 8 can be employed. This mark has one fine groove in 1 period. The mark has 2P as the fundamental period. The ±2^{nd} order diffraction light is also generated from the mark in addition to the 0-order light and the odd-order diffraction light. However, since the relation between the sum (NAi+NA) of numerical aperture NAi of the illumination optical system and numerical aperture NA of the image-forming optical system in alignment system AS, the shortest wavelength λ₀ of illumination light, and fundamental period P is as shown in equation (5) in the similar manner to the embodiment above, the ±2^{nd} order diffraction light is not be made incident on the image-forming optical system of alignment system AS. As a result, only the 0-order light and the ±1^{st} order diffraction light contribute to the spatial intensity image of wafer mark M formed on imaging device 60. Thus, similar to the embodiment above, the mark position can be detected from the fundamental frequency component of the intensity image created by the 0-order light and the ±1^{st} order diffraction light.

FIG. 9 shows an example of a mark on which fine grooves are formed while the duty ratio is maintained in 1:1, unlike the above-described mark. FIG. 9 is a view when the mark is viewed from above, and its measurement direction is in an X-axis direction. In FIG. 9, recessed portions (groove portions) of the mark are displayed in gray. The mark has the duty ratio between a light portion and a dark portion in the measurement direction of 1:1. Further, in the recessed portions of the mark, a corrugated pattern is formed also in a non-measurement direction (direction orthogonal to the measurement direction, which is the Y-axis direction in this case). Further, the duty ratio of the corrugation in the non-measurement direction is 1:1. Since the duty ratio of the mark is maintained in 1:1 in the measurement direction, diffraction light emitted from the mark is only odd-order, and the mark position can be measured with good accuracy using the odd-order spatial frequency component in the similar manner to the embodiment above. Further, since the mark has fine grooves arrayed in the non-measurement direction, the mark has a structure that is hard to be deformed in the CMP process, and mark symmetry in the measurement direction is maintained. When this type of mark is employed, the mark position can be measured highly accurately.

FIG. 10 shows another modified example of the mark. The recessed portions of the mark in the non-measurement direction are finer than those of the mark shown in FIG. 9. When this type of mark is employed, mark deformation by the CMP process is further reduced and the mark symmetry is maintained.

With regard to the mark where the symmetry is maintained, a mark image is hardly deviated laterally by defocus of a wafer surface from the best focus position of alignment system AS, so that error of a mark detection position due to defocus, can also be reduced.

Further, in the embodiment above, the depth of the recessed portions can be set to an arbitrary depth. This improves the degree of freedom in design of the mark. Further, although wafer mark M is a mark having the finer recessed portion than the protruding portion, wafer mark M may be a mark having a finer protruding portion than the recessed portion.

Note that the placement position of color filter 50 may be set to an area between the half mirror and the condenser lens. In the case chromatic aberration is small enough to be ignored, color filter 50 and spectrometer 59 may not be equipped. As is described above, various modifications can be made to the configuration of alignment system AS. Further, the wavelength of the illumination light of alignment system AS may be arbitrary as long as the wavelength is not a wavelength where resist is exposed, and a lamp may be other than a halogen lamp. Furthermore, a plurality of light sources that emit illumination light of single wavelength may be used to form illumination light having the wavelength width of a wide band.

Meanwhile, description has been made for the mark having the corrugated pattern in the embodiment above. However, a mark may be a light/dark mark where the light portion and the dark portion are arranged and formed in the similar manner to the protruding portion and the recessed portion in the above-described embodiment.

Note that the fiducial mark on fiducial mark plate FM and the reticle alignment mark on reticle R can also be fine-groove marks similar to the mark according to the embodiment above, and the present invention can be applied to them.

Further, in the embodiment above, global alignment such as the EGA method is employed as the alignment method, but it goes without saying that die-by-die alignment may be employed.

Further, in the embodiment above, the case has been described where KrF excimer laser light (248 nm) and ArF excimer laser light (193 nm) are used as the exposure light, but the present invention is not limited to this. A harmonic wave such as g-line (436 nm), i-line (365 nm), F2 laser light (157 nm), Ar₂ excimer laser (126 nm), copper vapor laser, YAG laser, semiconductor laser, or the like can be used as illumination light for exposure. Further, as the exposure light, as is disclosed in, for example, the pamphlet of International Publication No. 99/46835, a harmonic wave may also be used that is obtained by amplifying a single-wavelength laser beam in the infrared or visible range emitted by a DFB semiconductor laser or fiber laser, with a fiber amplifier doped with, for example, erbium (or both erbium and ytteribium), and by converting the wavelength into ultraviolet light using a nonlinear optical crystal.

Further, in exposure apparatus 100 of the embodiment above, as projection optical system PL, any one of a reduction system, an equal magnifying system and a magnifying system may be used, and the projection optical system may be any one of a dioptric system, a catadioptric system and a catoptric system. Note that projection optical system PL constituted by a plurality of lenses is assembled into the exposure apparatus main section. After that, optical adjustment is performed, the reticle stage and the wafer stage, which consist of a large number of mechanical parts, are attached to the exposure apparatus main section and wiring and piping are connected, total adjustment (such as electrical adjustment and operational check) is further performed, and thus the exposure apparatus of the embodiment above can be manufactured. Incidentally, it is desirable that the exposure apparatus is manufactured in a clean room whose temperature, cleanness and the like are controlled.

Meanwhile, the projection exposure apparatus by a step-and-scan method has been described in the embodiment above. However, the present invention can be applied to a projection exposure apparatus by a step-and-repeat method as a matter of course, and besides these projection exposure apparatuses, can also be applied to other exposure apparatuses such as an exposure apparatus by a proximity method. Further, the present invention can also be suitably applied to a reduction projection exposure apparatus by a step-and-stitch method where a shot area is synthesized with another shot area. Further, the present invention can also be applied to a twin-stage type exposure apparatus equipped with two wafer stages, as disclosed in, for example, the pamphlet of International Publication No. 98/24115, the pamphlet of International Publication No. 98/40791 and the like. Further, the present invention can also be applied to an exposure apparatus using a liquid immersion method as disclosed in the pamphlet of International Publication No. 99/49504.

Further, the usage of the present invention is not limited to an exposure apparatus for manufacturing semiconductor devices, but the present invention can also be applied to exposure apparatuses such as an exposure apparatus used for manufacturing displays including liquid crystal display devices that transfers a device pattern onto a glass plate, an exposure apparatus used for manufacturing thin film magnetic heads that transfers a device pattern onto a ceramic wafer, and an exposure apparatus used for manufacturing imaging devices (such as a CCDs), micromachines, organic EL, DNA chips or the like. Further, the present invention may also be applied to an exposure apparatus that uses EUV light (oscillation spectrum is 5 to 15 nm (soft X-ray region)), X-ray, or electron beam where lanthanum hexaboride (LaB₆) or tantalum (Ta) of a thermal electron emission type is used as an electron gun, and charged particle beam such as ion beam, as exposure beam.

Incidentally, in the embodiment above, a light transmissive mask (reticle) where a predetermined light-shielding pattern (or phase pattern, attenuation pattern) is formed on a light transmissive substrate, or a light reflective mask where a predetermined reflective pattern is formed on a light reflective substrate is used. However, instead of these masks, an electronic mask on which a transmissive pattern, a reflective pattern, or a light-emitting pattern is formed based on the electronic data of a pattern to be exposed may be used. Such an electronic mask is disclosed in, for example, the U.S. Pat. No. 6,778,257.

Meanwhile, the above-described electronic mask is a concept including both of a non-emissive image display device and a self-emissive image display device. Herein, the non-emissive image display device is also called a spatial light modulator that is a device that spatially modulates the state of light amplitude, phase or polarization, and the spatial light modulator is classified into a transmissive spatial light modulator and a reflective spatial light modulator. The transmissive spatial light modulator includes a transmissive liquid crystal display device (LCD), an electrochromic display (ECD) or the like. Further, the reflective spatial light modulator includes a DMD (Digital Mirror Device, or Digital Micro-mirror Device), a reflective mirror array, a reflective liquid crystal display device, an electrophoretic display (EPD), an electronic paper (or electronic ink), a grating light valve or the like.

Further, the self-emissive image display device includes a CRT (Cathode Ray Tube), an inorganic EL (Electro Luminescence) display, a field emission display (FED), a plasma display panel (PDP), a solid state light source chip having a plurality of light emission points, a solid state light source chip array where a plurality of chips are arranged in an array state, or a solid state light source array where a plurality of light emission points are fabricated on one substrate (such as an LED (Light Emitting Diode) display, an OLED (Organic Light Emitting Diode) display, or an LD (Laser Diode) display) or the like. Incidentally, removing a fluorescent material arranged for each pixel of a well-known plasma display (PDP) makes a self-emissive image display device that emits light in the ultraviolet region.

Further, the present invention can also be applied to an exposure apparatus that transfers a circuit pattern onto a glass substrate or a silicon wafer in order to manufacture not only a micro device such as a semiconductor device but also a reticle or a mask used in an optical exposure apparatus, an EUV exposure apparatus, an X-ray exposure apparatus, and an electron beam exposure apparatus or the like. Herein, a transmissive reticle is generally used in an exposure apparatus using DUV (deep ultraviolet) light, VUV (vacuum ultraviolet) light or the like, and silica glass, fluorine-doped silica glass, fluorite, magnesium fluoride, crystal or the like is used as a reticle substrate. Further, a transmissive mask (stencil mask, membrane mask) is used in an X-ray exposure apparatus by a proximity method, an electron beam exposure apparatus or the like, and a silicon wafer or the like is used as a mask substrate.

Further, in the embodiment above, it goes without saying that not only light having a wavelength equal to or more than 100 nm but also light having a wavelength less than 100 nm may be used as the exposure light of the exposure apparatus. For example, in recent years, in order to expose a pattern equal to or less than 70 nm, an EUV exposure apparatus that uses an SOR or a plasma laser as a light source to generate an EUV (Extreme Ultraviolet) light in a soft X-ray range (such as a wavelength range from 5 to 15 nm), and also uses a total reflection reduction optical system designed under the exposure wavelength (such as 13.5 nm) and the reflective mask has been developed. In the EUV exposure apparatus, the arrangement in which scanning exposure is performed by synchronously scanning a mask and a wafer using circular arc illumination can be considered.

Further, the present invention can also be applied to an exposure apparatus using charged particle beam such as electron beam and ion beam. Meanwhile, the electron beam exposure apparatus may employ any one of a pencil beam method, a variable shaping beam method, a cell projection method, a blanking aperture array method and a mask projection method. For example, an exposure apparatus using electron beam uses an optical system equipped with electromagnetic lenses.

Further, the alignment mark is not only used for alignment in an exposure apparatus. For example, the present invention can also be applied to a mark and an alignment system, which are used for alignment of an apparatus that requires alignment of a wafer when performing measurement, such as an overlay measuring instrument that measures the overlay error of shot areas on a wafer. Thus, a measurement apparatus that measures an alignment mark formed on an object or measures positional information of the mark can employ the present invention.

In other words, the pattern forming apparatus of the present invention is not limited to the exposure apparatus. The pattern forming apparatus only has to be equipped with the mark measurement apparatus of the present invention that measures positional information of a mark formed on an object, and a controller that controls the position of the object at the time of forming a pattern based on the positional information measured by the mark measurement apparatus. For example, the present invention can also be applied to a pattern forming apparatus similar to an element manufacturing apparatus equipped with a functional liquid applicator by an inkjet method similar to an inkjet head group, which is disclosed in, for example, Kokai (Japanese Unexamined Patent Application Publication) No. 2004-130312 and the like. The inkjet head group disclosed in the above publication has a plurality of inkjet heads that ejects predetermined functional liquid (such as liquid containing metal and photosensitive material) from nozzles (discharge ports) to apply the liquid on a substrate (such as PET, glass, silicon and paper). Therefore, positional information of a mark formed on the substrate is measured by a mark measurement apparatus, and the relative position of the substrate to the inkjet head group at the time of forming a pattern can be controlled by the controller based on the measurement result.

Note that the disclosures cited in the above-described various publications, pamphlets of International Publication, U.S. Patent Application Publications, and U.S. patents are fully incorporated herein by reference.

Micro devices are manufactured through a step of designing the function and performance of a device, a step of manufacturing a mask (reticle) based on the designing step, a substrate processing step, a device assembly step (including dicing process, bonding process and packaging process), an inspection step and the like. In the substrate processing step, a step of performing pre-processing process necessary for a substrate (such as wafer or glass plate), a step of transferring a pattern of the mask (reticle) on the substrate by the exposure apparatus of the embodiment above or the like, a step of developing the exposed substrate, a step of removing an exposed member on an area other than an area where resist is left by etching, a step of removing resist that becomes useless after completing etching, and the like are performed repeatedly.

Further, a pattern may be formed on a substrate using the above-described element manufacturing apparatus instead of exposing at least one layer out of the exposure of a plurality of layers performed in the above-described exposure apparatus. Also in this case, since a pattern can be formed highly accurately, as a consequence, it becomes possible to improve the productivity (including yield) of a device.

While the above-described embodiment of the present invention is the presently preferred embodiment thereof, those skilled in the art of lithography systems will readily recognize that numerous additions, modifications, and substitutions may be made to the above-described embodiment without departing from the spirit and scope thereof. It is intended that all such modifications, additions, and substitutions fall within the scope of the present invention, which is best defined by the claims appended below.

What is claimed is:

1. A mark structure, having
a periodic structure that weakens intensity of even-order diffraction light rather than intensity of odd-order diffraction light out of a plurality of diffraction lights of a predetermined order or under generated by irradiation of illumination light, and whose duty ratio is not 1:1.

2. The mark structure of claim 1 wherein
the periodic structure includes a first component using a first period as a fundamental period, and a second component using a second period as a fundamental period, the second period being an even-multiple of the first period.

3. The mark structure of claim 2 wherein
in the periodic structure,
a periodic corrugated pattern that uses the first period as a fundamental period and whose overall length in a period direction is half the second period is arranged in the second period, and
a width of a recessed portion of the corrugated pattern in the period direction is set to be shorter than half the first period.

4. A mark measurement apparatus that measures the mark structure of claim 1, the apparatus comprising:
an illumination optical system that illuminates the mark structure with predetermined illumination light; and
an image-forming optical system that guides the illumination light via the mark structure to form an intensity image of the mark structure, wherein
the sum of a numerical aperture of the illumination optical system and a numerical aperture of the image-forming optical system is set to be smaller than a value obtained by dividing a wavelength of the illumination light by the shortest period out of the fundamental periods of the mark structure.

5. The mark measurement apparatus of claim 4 wherein
the predetermined illumination light is light having a predetermined wavelength band, and
the sum of the numerical aperture of the illumination optical system and the numerical aperture of the image-forming optical system is set to be smaller than a value obtained by dividing the shortest wavelength of the illumination light by the shortest period out of the fundamental periods of the mark structure.

6. A pattern forming apparatus that forms a pattern on an object, comprising:
the mark measurement apparatus of claim 4 that measures positional information of a mark formed on the object; and
a controller that controls a position of the object at the time of forming the pattern, based on positional information measured by the mark measurement apparatus.

7. The pattern forming apparatus of claim 6 wherein
formation of the pattern on the object is performed by exposing the object with an energy beam.

8. A device manufacturing method, including:
a process in which a pattern is formed on an object using the pattern forming apparatus of claim 6; and
a process in which processing is applied to the object on which the pattern is formed.

9. A mark measurement apparatus that measures the mark structure of claim 1, the apparatus comprising:
an illumination optical system that illuminates the mark structure with illumination light having a predetermined wavelength band;
an image-forming optical system that guides the illumination light via the mark structure to form an intensity image of the mark structure;
a photoelectric conversion element that photoelectrically detects the intensity image;
a converter that performs the Fourier transform to a signal corresponding to the detected intensity image; and
a detection apparatus that detects positional information of the mark structure based on a phase obtained by the Fourier coefficient of an odd-order harmonic component of the Fourier spectrum of the signal.

10. The mark measurement apparatus of claim 9 wherein
the detection apparatus corrects the positional information of the mark structure based on information on chromatic aberration of the image-forming optical system.

11. The mark measurement apparatus of claim 10 wherein
the detection apparatus uses information on chromatic aberration that is different depending on an order of an odd-order harmonic component used to detect the positional information of the mark structure, when correcting the positional information of the mark structure.

12. The mark measurement apparatus of claim 10, further comprising:
a spectrometer that measures a spectral reflectance characteristic of the mark structure, wherein
the detection apparatus computes information on chromatic aberration of the image-forming optical system based on a spectral reflectance characteristic of the mark structure measured by the spectrometer with respect to a wavelength of the illumination light, and corrects the positional information of the mark structure based on the computed information on chromatic aberration of the image-forming optical system.

13. The mark measurement apparatus of claim 12, further comprising:
a color filter that can adjust a wavelength of diffraction light that contributes to image-forming of the intensity image, wherein
the color filter is used when obtaining a relation between the spectral reflectance characteristic of the mark structure in the spectrometer and a positional deviation of the intensity image of the mark structure.

14. A pattern forming apparatus that forms a pattern on an object, comprising:
the mark measurement apparatus of claim 9 that measures positional information of a mark formed on the object; and
a controller that controls a position of the object at the time of forming the pattern, based on the positional information measured by the mark measurement apparatus.

15. The pattern forming apparatus of claim 14 wherein
formation of the pattern on the object is performed by exposing the object with an energy beam.

16. A device manufacturing method, including:
a process in which a pattern is formed on an object using the pattern forming apparatus of claim 14; and
a process in which processing is applied to the object on which the pattern is formed.

17. A mark measurement apparatus, comprising:
an illumination optical system that illuminates a period mark with predetermined illumination light;
an image-forming optical system that guides 0-order diffraction light and odd-order diffraction light out of diffraction lights from the period mark to form an intensity image of the period mark;
a photoelectric conversion element that photoelectrically detects the intensity image;
a converter that performs the Fourier transform to a signal corresponding to the detected intensity image; and
a detection apparatus that detects a position of the period mark based on a phase obtained by the Fourier coefficient of an odd-order harmonic component of the Fourier spectrum of the signal.

18. The mark measurement apparatus of claim 17, further comprising:
a color filter that adjusts a wavelength of diffraction light that contributes to image-forming of the intensity image so that intensity of the 0-order diffraction light increases, wherein
the predetermined illumination light is one of light having a predetermined wavelength band and light having a wavelength selected from a plurality of wavelengths.

19. A pattern forming apparatus that forms a pattern on an object, comprising:
the mark measurement apparatus of claim 17 that measures positional information of a mark formed on the object; and
a controller that controls a position of the object at the time of forming the pattern, based on the positional information measured by the mark measurement apparatus.

20. The pattern forming apparatus of claim 19 wherein
formation of the pattern on the object is performed by exposing the object with an energy beam.

21. A device manufacturing method, including:
a process in which a pattern is formed on an object using the pattern forming apparatus of claim 19; and
a process in which processing is applied to the object on which the pattern is formed.

22. A mark structure including a corrugated pattern, having:
a first component using a first period as a fundamental period; and
a second component using a second period as a fundamental period, the second period being an even-multiple of the first period, wherein
a duty ratio of the corrugated pattern is not 1:1.

23. The mark structure of claim 22 wherein
a width of a recessed portion of the corrugated pattern in a period direction is set to be shorter than half the first period.

24. A substrate on which the mark structure of claim 22 is formed.

25. A glass substrate on which the mark structure of claim 22 is formed.

26. A semiconductor substrate on which the mark structure of claim 22 is formed.

27. A pattern forming method, comprising
irradiating exposure light on a glass substrate on which the mark structure of claim 22 is formed and forming the corrugated pattern on the substrate.

28. A detection method in which a mark structure including a corrugated pattern is detected, the method comprising:
irradiating illumination light on the mark structure via an illumination optical system;
collecting diffraction light generated from the corrugated pattern by irradiation of the illumination light on a light-receiving plane of a light-receiving element by an image-forming optical system; and
detecting positional information of the mark structure based on an image of the corrugated pattern detected by the light-receiving element, wherein
the sum of a numerical aperture of the illumination optical system and a numerical aperture of the image-forming optical system is set to be smaller than a value obtained by dividing a wavelength of the illumination light by the shortest period of the corrugated pattern.

29. The detection method of claim 28 wherein
the mark structure has a first component using the shortest period as a fundamental period and a second component using a second period as a fundamental period, the second period being an even-multiple of the shortest period.

30. A device manufacturing method in which a circuit pattern is formed on a substrate, comprising:
adjusting a position of the substrate based on positional information of a mark structure formed on the substrate that is detected using the detection method of claim 28, irradiating exposure light on the substrate, and forming the circuit pattern on the substrate.

31. A detection apparatus that detects a mark structure including a corrugated pattern, the apparatus comprising:
an illumination optical system that illuminates illumination light onto the mark structure; and
an image-forming optical system that forms an image of the corrugated pattern on a light-receiving plane of a light-receiving element, wherein
the sum of a numerical aperture of the illumination optical system and a numerical aperture of the image-forming optical system is smaller than a value obtained by dividing a wavelength of the illumination light by the shortest period of the corrugated pattern.

32. The detection apparatus of claim 31 wherein
the mark structure has a first component using the shortest period as a fundamental period and a second component using a second period as a fundamental period, the second period being an even-multiple of the shortest period.
